(19) United States
(12) Patent Application Publication
(10) Pub. No.: US 2013/0111382 A1
(43) Pub. Date: May 2, 2013

(54) DATA COLLECTION INTERACTION USING CUSTOMIZED LAYOUTS

(71) Applicants: Ted G. Glaza, Seattle, WA (US); Hamid Mahmood, Seattle, WA (US); Vincent Paul Sibal, Seattle, WA (US); Giacomo Antonio Friedemann Ferrari, Bellevue, WA (US); Bhadreshkumar D. Prajapati, Sammamish, WA (US); Narra Navin Kumar, Seattle, WA (US); Mark R. Rideout, Redmond, WA (US); Terry A. Adams, North Bend, WA (US)

(72) Inventors: Ted G. Glaza, Seattle, WA (US); Hamid Mahmood, Seattle, WA (US); Vincent Paul Sibal, Seattle, WA (US); Giacomo Antonio Friedemann Ferrari, Bellevue, WA (US); Bhadreshkumar D. Prajapati, Sammamish, WA (US); Narra Navin Kumar, Seattle, WA (US); Mark R. Rideout, Redmond, WA (US); Terry A. Adams, North Bend, WA (US)

(73) Assignee: MICROSOFT CORPORATION, Redmond, WA (US)

(21) Appl. No.: 13/287,665

(22) Filed: Nov. 2, 2011

(51) Int. Cl. G06F 3/048

(52) U.S. Cl. 715/765

(57) ABSTRACT

Embodiments are directed to providing support for customized element layouts in a user interface. In one scenario, a computer system provides a user interface (UI) for a software application. The user interface includes multiple different UI elements arranged according to a custom layout. The computer system receives a user input that indicates various user interaction characteristics that are to be customized for the UI by a custom layout panel. The custom layout panel selects a characteristic modification interface based on which user interaction characteristics are to be customized, and implements the selected interface to customize the indicated interaction characteristics. The interfaces customize user interaction characteristics including keyboard navigation characteristics, data virtualization characteristics, animation characteristics, live reordering characteristics and orientation characteristics

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Each software application has a user interface (graphical or otherwise) that allows a user to interact with the application. User interfaces typically include various different icons, menus, toolbars and other elements which the user can use to perform various functionality provided by the application. These icons and other elements may be arranged in a certain predefined manner for each application. This arrangement may be referred to as a layout. Each element in a layout may include an associated control which dictates how user inputs directed at that element will be handled. In some cases, customizable layouts may be used. In such cases, application developers that design the controls for the user interface elements may not be able to accurately anticipate the operating characteristics of the layout.

### BRIEF SUMMARY

Embodiments described herein are directed to providing support for customized element layouts in a user interface. In one embodiment, a computer system provides a user interface (UI) for a software application. The user interface includes multiple different UI elements arranged according to a custom layout. The computer system receives a user input that indicates various user interaction characteristics that are to be customized for the UI by a custom layout panel. The custom layout panel selects a characteristic modification interface based on which user interaction characteristics are to be customized, and implements the selected interface to customize the indicated interaction characteristics. The interfaces customize user interaction characteristics including keyboard navigation characteristics, data virtualization characteristics, animation characteristics, live reordering characteristics and orientation characteristics.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments of the invention may be realized and obtained by means of the instruments and combinations particularly pointed out in the appended claims. Features of the embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The embodiments of the invention will be described and explained with additional specificity and detail through the use of the accompanying drawings in which:

FIG. 1 illustrates a computer architecture in which embodiments of the present invention may operate including providing support for customized element layouts in a user interface.

FIG. 2 illustrates a flowchart of an example method for providing support for customized element layouts in a user interface.

FIG. 3 illustrates an embodiment of a custom layout panel with multiple different characteristic modification interfaces.

### DETAILED DESCRIPTION

Embodiments described herein are directed to providing support for customized element layouts in a user interface. In one embodiment, a computer system provides a user interface (UI) for a software application. The user interface includes multiple different UI elements arranged according to a custom layout. The computer system receives a user input that indicates various user interaction characteristics that are to be customized for the UI by a custom layout panel. The custom layout panel selects a characteristic modification interface based on which user interaction characteristics are to be customized, and implements the selected interface to customize the indicated interaction characteristics. The interfaces customize user interaction characteristics including keyboard navigation characteristics, data virtualization characteristics, animation characteristics, live reordering characteristics and orientation characteristics.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmissions media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

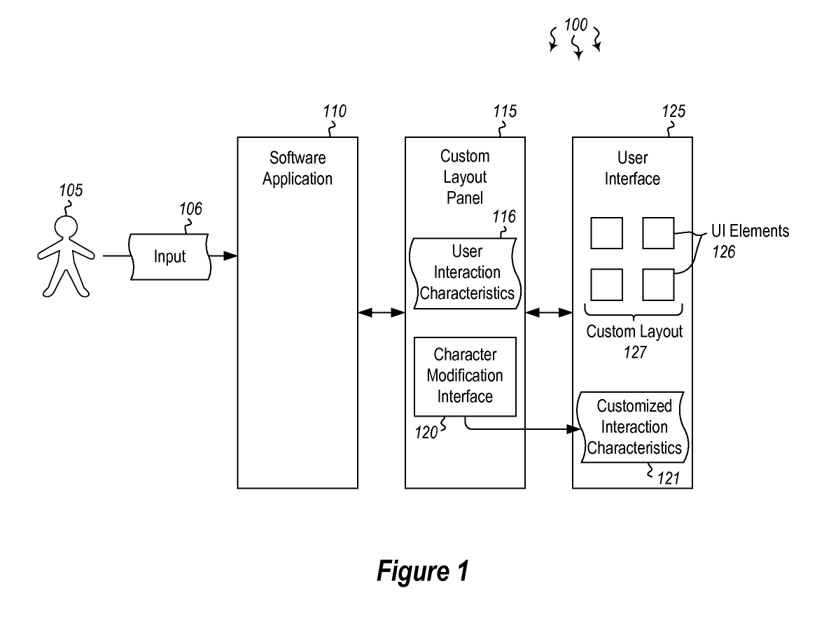

FIG. 1 illustrates a computer architecture 100 in which the principles of the present invention may be employed. Computer architecture 100 includes various different components which are configured to perform different portions of functionality. For example, software application 110 may be configured to perform different functions, depending on what the application was designed for. The application has a user interface 125 that allows user 105 to interact with the application. The user 105 may be an end user, an application developer, a computer administrator, or other user. The user interface (UI) provides various icons, menus, buttons, toolbars and other elements that allow the user to interact with the application. For instance, a user may select an icon shaped like a floppy disk to save a document, or a folder-shaped icon to open a document. In such a manner, the user interacts with the UI.

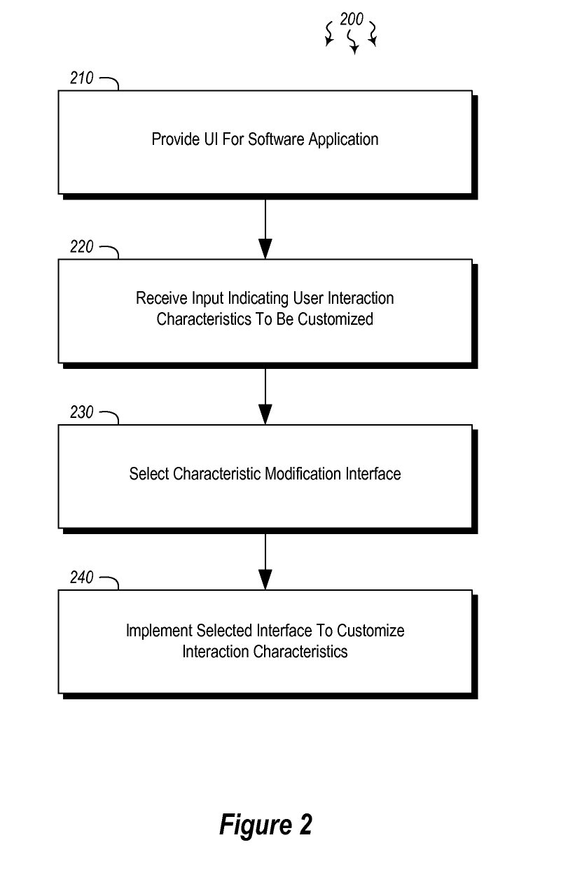

In some cases, the UI may be of a variable size. For example, a software application may be designed for use on different types of displays or devices. In one case, an application may be designed to work on a smart phone, on a tablet computer system, and on a normal desktop or laptop computer system. In each case, the layout of the UI may allow more or fewer UI elements, and may arrange the elements in a different manner based on which device the application is used on. In some embodiments, other user interactions characteristics may be taken into account. For example, keyboard navigation may be different when the application is used on different devices. As such, a specific interface may be used to modify the keyboard navigation settings for that application on that device. The custom layout panel 115 may be used to apply different user interaction characteristics to different UIs or to different UI elements. These concepts will be explained in greater detail below with regard to method 200 of FIG. 2.

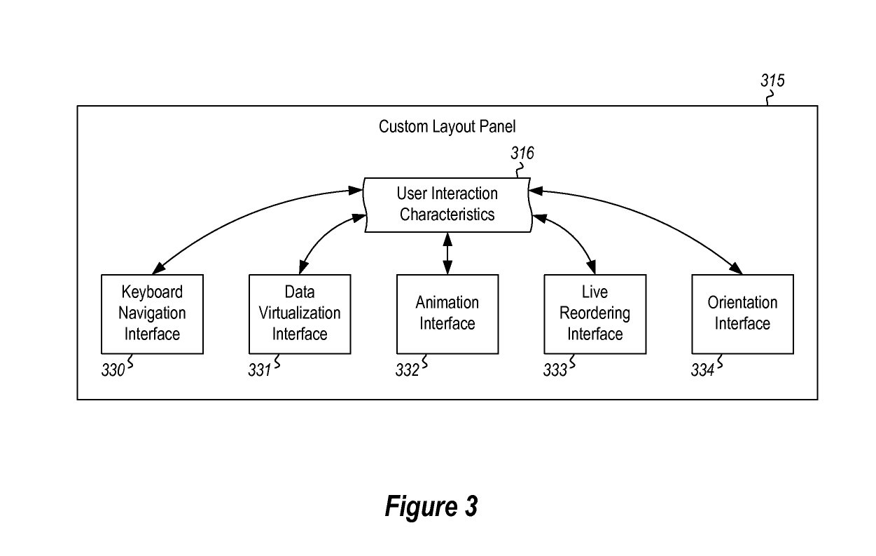

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for providing support for customized element layouts in a user interface. The method 200 will now be described with frequent reference to the components and data of environment 100 of FIG. 1, and the custom layout panel 315 of FIG. 3.

Method 200 includes an act of providing a user interface (UI) for a software application, the user interface including a plurality of UI elements arranged according to a custom layout (act 210). For example, a computer system such as a desktop or laptop, tablet, smart phone or other (e.g. distributed) computer system may provide a software application 110 and associated user interface 125. The UI may include various different UI elements 126 arranged according to a custom layout 127. The custom layout may include more or fewer elements than those shown in FIG. 1, and it will be understood that substantially any number of elements may be shown and used in UI 125. Moreover, the number and configuration of elements in the UI may vary depending on computer system type, display type (e.g. if the tablet display is being projected on another display), user settings or other elements that may alter the layout.

Method 200 also includes an act of receiving a user input that indicates one or more user interaction characteristics that are to be customized for the UI by a custom layout panel (act 220). For example, software application 110 may receive user input 106 from user 105 indicating various different interaction characteristics that are to be customized by the custom layout panel 115. As indicated above, the user may be a software application developer, or, in some cases, may be an end user. As mentioned above, the custom layout panel may be used to apply different user interaction characteristics 116 to the UI elements 126 of UI 125. The custom layout panel 115 may implement the changes indicated by the user by applying a characteristic modification interface. These interfaces may be used singly, or in combination with other interfaces.

Based upon the input received from the user indicating which user interaction characteristics are to be customized, the custom layout panel can select a characteristic modification interface 120 based on which user interaction characteristics are to be customized (act 230). Although five different interfaces are described below (e.g. keyboard navigation, data virtualization, animation, live reordering and orientation), it will be noted that other interfaces may be used to control different aspects of the user's interaction with the software application's UI. Moreover, at least in some cases, third parties may provide their own custom interfaces to modify how users interact with the software application. Still further, it should be noted that, at least in some cases, an application developer may not choose to give the end user an opportunity to select which interaction characteristics are to be customized. In such cases, the developer may simply decide which user interaction characteristics are to be modified.

As shown in FIG. 3, custom panel 315 may implement keyboard navigation interface 330 to modify keyboard navigation characteristics (which may be all or part of user interaction characteristics 316). Accordingly, when the application developer or end user 105 indicates via input 106 that one or more keyboard navigation characteristics are to be modified, interface 330 may be invoked by the custom layout panel. The keyboard navigation interface may apply one or more predetermined or user-selected settings that dictate how keyboard navigation works within the software application UI 125. In this manner, keyboard navigation may be customized for each UI and/or device on which the UI is used.

In some embodiments, the keyboard navigation interface 330 may be configured to perform the following steps: 1) send an indication of the UI element that currently has focus to the custom layout panel 315, and 2) send an indication of the user's keyboard input to the custom layout panel. The keyboard input may be any type of keyboard input, including any combination of keystrokes. The custom layout panel determines, based on the currently focused element and the user's keyboard input which UI element focus is to be switched to. Thus, if the UI elements are laid out in a grid (as in FIG. 1), and focus is currently on the top right element, if the received user input is the up arrow, the custom layout panel may determine that focus is to be moved to the bottom left UI element, as it is the next item in the grid's ordering. The UI may then provide a visual indication of where the currently focused element is and where the focus is to be switched to based on the user's input gesture. It should be noted that this is merely one example of a keyboard navigation input, and is merely one example of how the actual navigation may be arranged. Software UI developers (and, in some cases, end users) may be able to select how different keyboard navigation inputs are applied to different layouts and different applications.

The custom layout panel 315 may also implement a data virtualization interface 331. The data virtualization interface may be configured to perform the following steps: 1) determine the size of the display for the UI (in pixels, centimeters or some other measurement), 2) determine the size of the UI elements being shown on the display (again, in pixels, centimeters or other), and 3) based on the size of the display and the size of the UI elements, determine how many UI elements are to be virtualized (i.e. loaded into memory) and shown on the display. Accordingly, as each display may be of a different size, a different number of UI elements may be shown. Thus, for a larger display that may show more elements, a larger number of UI elements would be virtualized. Similarly, a smaller display that shows fewer elements may have a fewer number of elements virtualized. Other embodiments are also possible such as when a large screen with (comparatively) large UI elements is used for a user who is seeing impaired. In such cases, fewer UI elements would be virtualized, even though the screen size is larger. As with the keyboard navigation interface, many different implementations are possible, and the above examples are not intended to be limiting.

The data virtualization interface may determine an index for the last UI element of a page of UI elements to initiate virtualization of a subsequent page of elements. Thus, in cases where different pages of data are being shown, the data virtualization interface determines which page is being shown and which is the next to be loaded. The subsequent page may then be virtualized in preparation for the user navigating to (or otherwise requesting) that page.

The custom layout panel 315 may also include an animation interface 332 configured to perform the following: 1) determine clipping boundaries for one or more of the UI elements, 2) identify the portion of the display actually being used by the UI elements, and 3) based on the clipping boundaries and the used portion of the display, determine animation constraints for animating the UI elements. Thus, for example, in FIG. 1, if a new element were to be inserted between the top left element and the bottom left element, and the layout were a grid with two rows, the bottom left element would be animated to move to the top right position and the other elements would be shifted appropriately. The custom layout panel may use the animation interface to determine the appropriate clipping boundaries for each element and how much of the display the UI elements are using. Based on these determinations, the custom layout panel may animate one or more of the UI elements using the determined constraints. When the new element is added (or when a given element has current focus), the other elements currently on the screen may be referred to as background elements, and may be animated vertically, horizontally, or a combination of vertically and horizontally into a new position using the determined constraints. In some cases, these background elements may be moved dynamically, while the user is dragging and dropping items using touch or other gestures.

The custom layout panel 315 also includes live reordering interface 333. The live reordering interface may be configured to perform the following steps: 1) determine indices for one or more background UI elements, 2) determine the current location of the element being repositioned, 3) determine which background elements will be affected by repositioning the element to the current location, and 4) dynamically move the background elements to accommodate the repositioned element. Thus, as mentioned above in conjunction with the animation module, the live repositioning module may dynamically move background elements to accommodate a newly positioned, newly added or deleted, or otherwise changed element. The UI elements may be reordered according to the specified custom layout (e.g. list (vertical or horizontal), grid, circular layout or other layout). As the UI element is being added, moved or otherwise reordered, the UI may provide a visual cue (e.g. a highlight, an outline, an increase in opacity, or other visual cue) of where the repositioned element is to be added to the layout. The background UI elements are animated into their new positions using the animation interface. Accordingly, the animation interface may work in conjunction with the live reordering interface (among other interfaces in the custom layout panel).

The custom layout panel 315 also includes an orientation interface 334. The orientation interface may be configured to perform the following steps: 1) determine to which part of the layout new UI elements are added, and 2) determine, based on which part of the layout new UI elements are added to, which direction the custom layout is oriented. Thus, the orientation interface may determine where new elements are being added and determine, based on where the new elements were inserted, which direction the custom layout is oriented. The orientation interface may also be used to determine which direction to enable scrolling of elements. In one example, if a new element is added and is placed at the bottom of a list, the orientation interface may determine that the layout is oriented vertically. Alternatively, if an element is added to a list and is placed to the right (or left) of the other elements, the orientation interface may determine that the layout is oriented horizontally. This interface may be used in conjunction with the animation interface, the live reordering interface, the data virtualization interface and/or the keyboard navigation interface. The custom layout panel implements the selected interface(s) to customize the interaction characteristics indicated by the user (act 240).

Using these interfaces, a user or application developer may be able to customize how a user interacts with a software application UI. By modifying these user interaction characteristics, an application developer may adapt UI interaction for a variety of different user interfaces and display type. Accordingly, methods, systems and computer program products are provided which provide support for customized element layouts in a user interface.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one processor and a memory, a computer-implemented method for providing support for customized element layouts in a user interface, the method comprising:
an act of providing a user interface (UI) for a software application, the user interface including a plurality of UI elements arranged according to a custom layout;
an act of receiving a user input that indicates one or more user interaction characteristics that are to be customized for the UI by a custom layout panel;
an act of the custom layout panel selecting a characteristic modification interface based on which user interaction characteristics are to be customized; and
an act of the custom layout panel implementing the selected interface to customize the indicated interaction characteristics.

2. The method of claim 1, wherein the characteristic modification interface comprises a keyboard navigation interface configured to perform the following:
send an indication of the currently focused UI element to the custom layout panel; and
send an indication of the user's keyboard input to the custom layout panel, wherein the custom layout panel determines, based on the currently focused element and the user's keyboard input which UI element focus is to be switched to.

3. The method of claim 1, wherein the characteristic modification interface comprises a data virtualization interface configured to perform the following:
determine the size of a display that displays the UI;
determine the size of the UI elements being shown on the display; and
based on the size of the display and the size of the UI elements, determine how many UI elements are to be virtualized and shown on the display.

4. The method of claim 3, wherein the data virtualization interface determines an index for the last UI element of a page of UI elements to initiate virtualization of a subsequent page of elements.

5. The method of claim 1, wherein the characteristic modification interface comprises an animation interface configured to perform the following:
determine clipping boundaries for one or more of the UI elements;
identify the portion of the display actually being used by the UI elements; and
based on the clipping boundaries and the used portion of the display, determine animation constraints for animating the UI elements.

6. The method of claim 1, wherein the characteristic modification interface comprises a live reordering interface configured to perform the following:
determine indices for one or more background UI elements;
determine the current location of the element being repositioned;
determine which background elements will be affected by repositioning the element to the current location; and
passing information indicating which background elements will be affected by repositioning the element to the current location to the custom layout panel, such that the custom layout panel dynamically moves the background elements to accommodate the repositioned element.

7. The method of claim 6, wherein the background elements are moved at least one of vertically and horizontally.

8. The method of claim 6, wherein the UI elements are laid out according to a grid layout, and wherein a top element is moved up and a bottom element is moved down, such that the repositioned data item is inserted into the grid of UI elements.

9. The method of claim 6, further comprising providing a visual cue of where the repositioned element is to be added to the layout.

10. The method of claim 9, wherein the background UI elements are animated into new positions using the animation interface.

11. The method of claim 1, wherein the characteristic modification interface comprises an orientation interface configured to perform the following:
determine to which part of the layout new UI elements are added; and
determine, based on which part of the layout new UI elements are added to, which direction the custom layout is oriented.

12. The method of claim 1, wherein a plurality of different characteristic modification interfaces are used in conjunction to customize user interaction with the UI.

13. The method of claim 1, wherein the custom layout is of a variable size and layout configuration.

14. The method of claim 1, further comprising providing one or more of the characteristic modification interfaces to a third party for integration in a third party custom layout panel.

15. At a computer system including at least one processor and a memory, a computer-implemented method for providing support for customized element layouts in a user interface, the method comprising:
an act of providing a user interface (UI) for a software application, the user interface including a plurality of UI elements arranged according to a custom layout;
an act of receiving a user input that indicates one or more keyboard navigation user interaction characteristics that are to be customized for the UI by a custom layout panel;
an act of the custom layout panel selecting a keyboard navigation interface to customize the keyboard user interaction characteristics; and
an act of the custom layout panel implementing the keyboard navigation interface to customize the keyboard user interaction characteristics, wherein the keyboard navigation interface performs the following:
sends an indication of the currently focused UI element to the custom layout panel; and
sends an indication of the user's input gesture to the custom layout panel, wherein the custom layout panel determines, based on the currently focused element and the user's input gesture which UI element focus is to be switched to.

16. The method of claim 15, further comprising providing a visual indication of where the currently focused element is and where the focus is to be switched to based on the user's input gesture.

17. The method of claim 15, wherein the keyboard navigation interface is used in conjunction with at least one of the following: a data virtualization interface, an animation interface, a live reordering interface and an orientation interface.

18. A computer system comprising the following:
one or more processors;
system memory;
one or more computer-readable storage media having stored thereon computer-executable instructions that, when executed by the one or more processors, causes the computing system to perform a method for providing support for customized element layouts in a user interface, the method comprising the following:
an act of providing a user interface (UI) for a software application, the user interface including a plurality of UI elements arranged according to a custom layout;
an act of receiving a user input that indicates one or more animation user interaction characteristics that are to be customized for the UI by a custom layout panel;
an act of the custom layout panel selecting a navigation interface to customize the keyboard user interaction characteristics; and
an act of the custom layout panel implementing the animation interface to customize the animation user interaction characteristics, wherein the animation interface performs the following:
determines clipping boundaries for one or more of the UI elements;
identifies the portion of the display actually being used by the UI elements; and
based on the clipping boundaries and the used portion of the display, determines animation constraints for animating the UI elements.

19. The computer system of claim 18, wherein the custom layout panel implements the animation interface to animate one or more UI elements using the determined constraints.

20. The computer system of claim 18, wherein one or more background elements are animated at least one of vertically and horizontally into a new position using the determined constraints.
